(19) United States
(12) Patent Application Publication
(10) Pub. No.: US 2017/0325623 A1
(43) Pub. Date: Nov. 16, 2017

(54) COMMERCIAL TEA BREWING STATION

(71) Applicant: Wilbur Curtis Company, Montebello, CA (US)

(72) Inventor: Lucian Hite Lyall, III, Lake Forest, CA (US)

(21) Appl. No.: 15/151,212

(22) Filed: May 10, 2016

(51) Int. Cl. A47J 31/41; A47J 31/46; A47J 31/00

(52) U.S. Cl. CPC A47J 31/41; A47J 31/007; A47J 31/46

(57) ABSTRACT

A commercial tea brewing station entrains a hot tea flow through a brew basket with an intermittent liquid sweetener flow to dissolve the liquid sweetener in the hot tea brew. A high velocity diluting flow is delivered to the concentrated sweetened tea at an angle to create turbulent back flow, further promoting complete mixing and dissolving of the sweetener and the diluting water, so that no manual mixing step is required.

### BACKGROUND

Sweet tea is sometimes referred to as “the house wine of the South.” And in the past decade, its popularity has been spreading across this thirsty country. Both traditional and fast food restaurants are making sweet tea available to their patrons from coast to coast. In the last ten years, sweet tea has gone from a regional favorite to a national staple. Southerners have been taking their tea cold and sweet for a long time. Some of the oldest recipes for sweet tea can be found in 19th-century Southern cookbooks, including an 1878 one from Housekeeping in Old Virginia by Marion Cabell Tyree, a granddaughter of Patrick Henry. The rest of the country caught on in the early 1900s, particularly after iced tea was popularized at the 1904 World's Fair in steamy St. Louis.

In the recent years, Americans have been cutting back on soda and instead drinking beverages such as smoothies, flavored water, specialty coffee drinks and iced tea. The NPD Group, a consumer research company, says iced tea sales at fast-food and casual dining restaurants have gone up about 12 percent since 2001, while soda consumption slipped 2 percent last year. According to the Tea Association of the United States, an industry trade group, Americans have been drinking tea at a record rate, especially the already-prepared kind. Ready-to-drink tea has dramatically increased in the last 15 years, where sales have jumped from $200 million to more than $3 billion last year, and iced tea makes up nearly 85 percent of the tea Americans consumed.

There are two basic techniques for making iced tea: hot-brewed and cold-brewed. Hot-brewed—pouring boiling water over tea leaves, letting it steep a few minutes, removing the tea leaves, stirring in sugar and cooling in the fridge—is more expedient. But many believe that the slower, cold-brewed method results in a smoother, more flavorful iced tea that doesn't turn cloudy. For cold-brewed, the tea is steeped for 30 minutes or more in cold water, or longer in the refrigerator. In the restaurant business, hot-brewed tea is the tea of choice because a batch of teach can be brewed more quickly, which allows the restaurant to meet the needs of the customers better.

Stations have been designed to brew tea for commercial establishments such as restaurants and fast food/convenience stores. These stations use pre-packaged tea packets or bags, and near boiling water is poured over the tea to allow the tea favor to be released. For sweet tea, once the tea is brewed a large quantity of granulated sugar is added to the tea for sweeting, but the tea must be stirred to dissolve the granulated sugar that collects at the bottom of the tank or reservoir. This stirring step is manually effected and can lead to inconsistent results, unsanitary conditions (the mixer's hand, sleeve, wrist watch, etc. can often get wetted as the tea is manually stirred), and this also adds time to the preparation of the tea. Restaurant owners want to avoid manual interaction of the tea brewing station, but thus far there have been no satisfactory stations for making sweet tea that fully automate the procedure and reliably produce a consistent batch of tea.

To produce an automated sweet tea brewing station, one must account for the tea brewing process, the dilution process to convert the one part concentrated tea into a four part diluted tea for drinking, and incorporate the sweeting process that eliminates the need for stirring of the tea after adding sweetener. The present invention seeks to address these objects with a fully automated sweet tea brewing station.

### SUMMARY OF THE INVENTION

The present invention is a tea brewing station that injects liquid sweetener into the hot tea stream at a selected interval to blend the tea and sweetener over the course of the brewing operation. By intermittently introducing the sweetener into the hot concentrated tea, the sweetener is mixed and warmed by the hot tea to promote absorption of the sweetener into the tea. The sweetener is added using a feedback system utilizing a pressure switch and a gas driven pump that provides volumetric accuracy at any viscosity or syrup temperature. The pressure switch on the pump may include a bleed hole to count the pulse on the pressure switch and then immediately bleed off pressure.

By introducing the sweetener directly into the hot tea stream, the sweetener is dissolved into the tea to obviate a mixing step. By intermittently introducing the syrup, the dissolving can take place over the entire tea brewing operation rather than all at once. Moreover, the diluting stream is introduced at a high velocity and angled to promote turbulent mixing of the tea and sweetener as eddies agitate the fluid and circulate the sweetener throughout the tea. This diluting stream is selected so as to be of a chilled temperature so that the fully brewed tea is ready to serve when the brewing operation is complete, as opposed to requiring a cooling or icing stage before serving.

### BRIEF DESCRIPTION OF THE DRAWINGS

FIG. 1 a schematic diagram of a first embodiment of the present invention;

FIG. 2 is a schematic diagram of the electrical control of the present invention;

FIG. 3 is a schematic diagram of the control board of the present invention;

FIG. 4 is an elevated, perspective view of a first preferred embodiment of the present invention;

FIG. 5 is a side view of the embodiment of FIG. 4 with the tea and sweetener flowing into the reservoir; and

FIG. 6 is a side view of the embodiment of FIG. 4 with the diluting chilled water agitating the mixture.

### DETAILED DESCRIPTION OF THE PREFERRED EMBODIMENTS

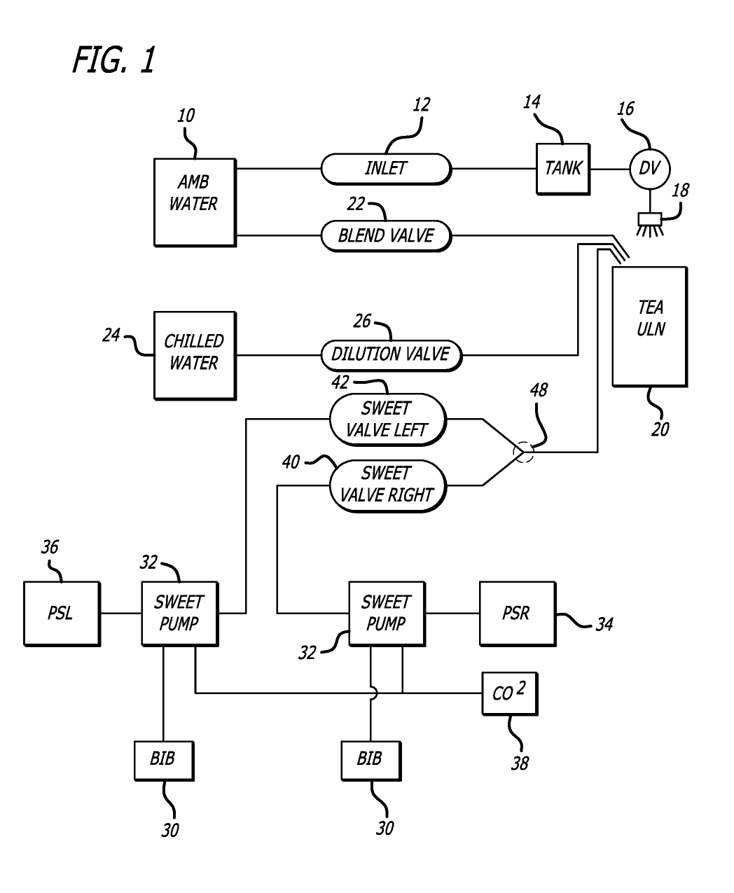

FIG. 1 illustrates a schematic diagram of a first preferred embodiment of a commercial sweet tea brewing station. A first ambient water supply 10 is connected via an inlet 12 to a heated water tank 14, where the ambient water is heated to a near boiling temperature for brewing the tea. The heated water from tank 14 is fed into a dump valve 16 for steeping a filtered package of tea 18. The heated water flows over and through the package 18, and the hot brewed tea flows in a stream from a nozzle on the brew basket into an urn 20. In a typical brewing operation, this brewing of the tea can take between four and one half to nine minutes to brew one gallon of concentrated tea. For an exemplary brewing operation, three gallons of diluting water is added to the hot concentrated brewed water. The ambient water supply 10 feeds a blend valve 22 that is also directed to the urn 20, but the majority of the dilution is achieved by directing chilled water from a chilled water supply 24. The chilled water supply 24 supplies cold water through a dilution valve 26 to the urn 20, to convert the concentrated brewed tea to a diluted drinkable tea according to a predetermined ratio (e.g., 3 to 1). The operation of the dilution valve 26 is controlled by the universal control module (“UCM”) 100, described more fully below.

The sweetening step is driven by the UCM 100, and begins with a pair of sweetener bibs 30, in the form of liquid syrup in ready to transfer packaging. The bibs 30 are connected to sweetener pumps 32, which are manipulated by a right pump switch 34 and a left pump switch 36, and driven by a carbon dioxide canister 38. The CO₂ canister 38 pushes the sweetener through the pumps 32 and through the right sweetener valve 40 and left sweetener valve 42. The sweetener passed through the sweetener valves 40,42 and the lines converge at a Y fitting 48 and injected into the tea stream into the urn 20. An important feature of the sweetener delivery system is that the pumps are designed to deliver a precise amount of sweetener regardless of the viscosity, temperature, or flow characteristics of the sweetener. This is achieved by pressure switches 34,36 which include a bleed hole that can be used to count pulses on the pressure switches. As pressure accumulates from the CO₂ canisters, the pressure is bled off in response to the pulse count to automatically deliver a constant volume of liquid sweetener without respect to its temperature or viscosity.

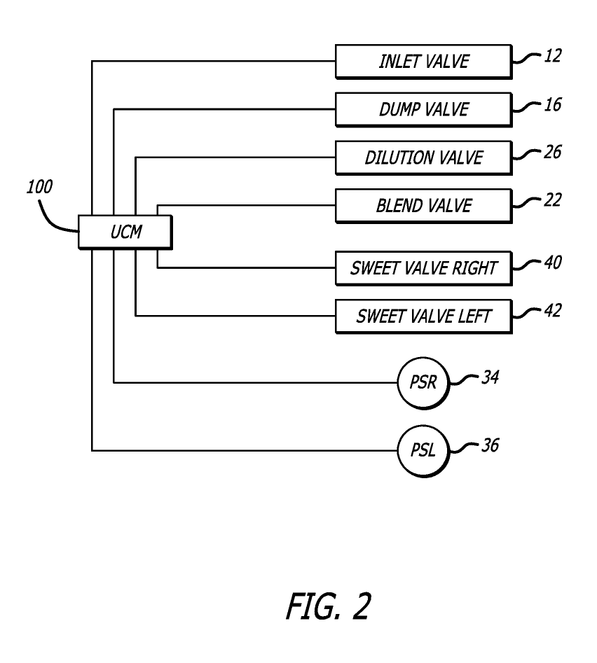

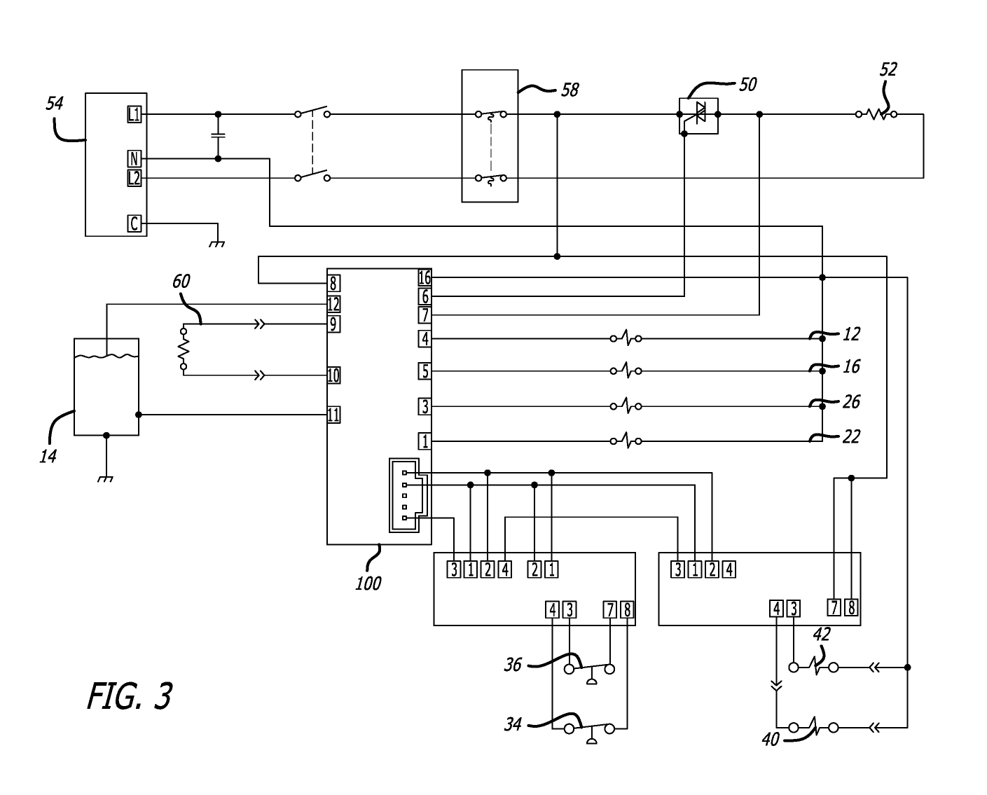

FIG. 2 illustrates a schematic diagram of the Universal Control Module 100, and the operation of the electrical system. The UCM 100 is connected to the inlet valve 12 and controls the flow of the ambient water 10 into the heater tank 14. The UCM 100 also controls the dump valve 16 that moderates the flow of heated water introduced at the tea packet 18. The UCM 100 also is tasked with the dilution operation by controlling the blend valve 22 and the dilution valve 26. In the sweetening stage, the UCM is connected to the right and left sweetener valve 42,40, as well as the pump switches 34,36. As the central control unit, the UCM 100 controls all of the flows into the urn including the hot water, the chilled water, the diluting water, and the sweetener. FIG. 3 illustrates the circuit diagram of these connections in a more detailed manner. As shown, the universal control module 100 is the central operator of the system. The blend valve 22, chilled dilution valve 26, brew valve 16, and inlet valve 12 are directly connected to pins on the UCM board. A triac 50 opens and closes the circuit for the heating element 52, which is powered by a power block 54 and separated by a manual reset switch 58. The UCM also controls the temperature of the heating tank 14 via a temperature sensor 60. The UCM 100 is also shown to control both the sweetener valves 40,42 and pressure switches 34,36 to monitor and adjust the sweetener flow into the urn 20.

The brew station brews sweet tea with the dump valve 16 and adds sweetener from two different sweetener pump circuits through the sweetener valves 40,42. After a fixed thirty second delay from the start, these sweetener circuits operate to, for example, forty-two counts, along with the dilution valve. At thirty seconds from the end of the drip mode a high flow (two GPM) blending valve 22 opens for approximately thirteen seconds to blend the complete brew by a vortex action. This requires that the nozzle for the blend valve be slightly askew and off-center to swirl the water in the urn 20, generating the mixing vortex.

The brew sequence will now be described. The brew starts with the UCM 100 instructing the dump valve 16 to open for between four and one half and nine minutes. After three hundred seconds from the brew start, the UCM opens the dilution valve 26. After a thirty second fixed delay from the brew start, the UCM 100 opens the left sweetener valve 42 (left is the default priority) and then the right sweetener valve 40. The sweetener valves stay open until the first of forty-two counts from the pressure switches 34,36, which must be done within ten seconds. As soon as one count is made the left sweetener valve 42 closes and waits for ten seconds until the total default of 42 is reached. The feedback count will happen at different time based upon sweetener temperature, which is programmable 39-45 with a forty-two count default.

Once a sweetener bib 30 is empty and there is no pulse count from that side within sixty seconds, the system will switch to the other side, display “SWEETENER EMPTY,” backlight flashing. The brewing operation continues to brew on the other bib side while monitoring the empty power switch for one pulse. This pulse will happen when a new bib 30 is connected and may be many hours later, and the SWEETENER EMPTY display will be cleared. The continue button may also be selected after the empty bib is replaced to clear the error message. During the empty bib scenario, the full side will only allow eight brews of sweet tea until the empty bib is replaced and the sweetener empty message is cleared. This prevents an incomplete batch from being brewed due to exhaustion of the sweetener supply. Once the empty bib is replaced, the one pulse will be seen and clear the display to keep brewing without restriction.

Once the dump valve 16 closes, the drip mode time begins. The UCM 100 allows between four and one half to nine minutes of drip brew time for a brew cycle. The blend mode begins where the blend valve 22 opens for thirty seconds before the drip mode time expires and is programmable from 0-30 seconds. At the end of the drip mode, the brew is complete and the program returns to “Ready to Brew.”

The sweetener delivery system is driven by the CO₂ canister and the pressure switches 34,36 and injects sweetener in specific volumetric quantities that is independent of temperature or viscosity. The pressure switches include a bleed hole to count the pulse on the pressure switch and then immediately bleed off pressure. Moreover, the sweetener can be introduced directly into the hot tea stream by angling the jet so that the two streams coalesce. Where the tea is falling vertically downward, the sweetener jet may be angled downward at an angle of between negative 45 and negative seventy five degrees so that the two streams created a confluence of the two streams. The hot tea serves to heat the sweetener, making the dissolving of the sweetener into the tea more efficient. Without this feature, the cooler sweetener is more likely to collect at the bottom of the urn and either require some manual mixing or require some other mixing step. Thus, the heating and mixing of the sweetener by introducing it into the hot tea stream overcomes the issues found in the prior art systems. In addition, the pulsing of the sweetener using intermediate shots of sweetener rather than introducing all of the sweetener at once allows greater dissolving of the sweetener. In one example, the sweetener is introduced for one second in every ten seconds over the course of the entire brewing operation, and this allows the sweetener to be introduced throughout the entire brewing operation. That is, if the brewing operation is six minutes then the sweetener is injected at intervals evenly spaced over the six minutes from beginning to end (the same with four and one half or nine minute brewing cycles). When the brew cycle is complete, all of the sweetener is evenly distributed and the need for stirring is obviated.

To enhance the mixing, the blend valve 22 delivers water through a high velocity jet to agitate and stir the tea mixture. The high velocity jet is preferably offset from the tea stream to swirl and agitate the tea mixture and create a circulation flow inside urn 20. By using chilled water as the dilution supply, the final brewed tea product is both blended and at serving temperature, allowing the beverage to be served at the completion of the brewing cycle and allow any necessary ice in the cup to last significantly longer. In the fast food environment, the preservation of the ice is important to customers who do not want their iced tea to be just tea minutes later.

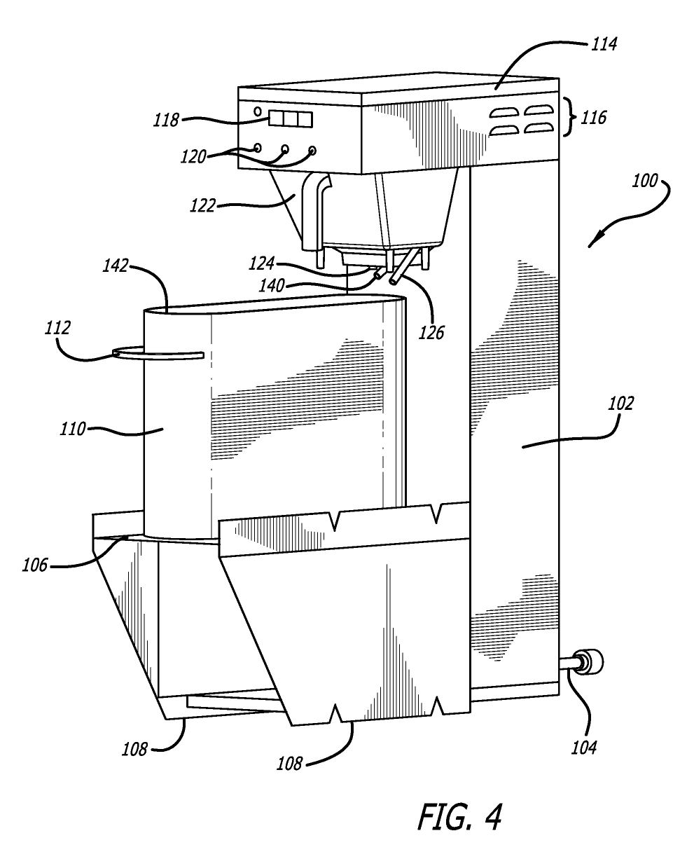

FIG. 4 depicts a housing 101 that brews and collects the sweet tea from the one step station. The housing 100 comprises a column base 102 with a conduit 104 connected to a supply of fresh water. The base 102 includes heating elements and a pump (not shown) that direct the some of the fresh water through the heating elements so that the water can be heated to a brewing temperature, while another portion of the fresh water is either not heated or chilled for diluting the tea. Adjacent the base 102 is a platform 106 supported by side walls 108, upon which is seated a dispensing bin 110. The dispensing bin 110 has an open top and handles 112 for carrying the bin from the brewing station to a serving station. Mounted at the top of the base 102 is a brewing apparatus 114 that houses the universal control module 100 and the electronics of FIG. 2. The brewing apparatus includes vents 116 to release steam that may accumulate during the brewing step and prevent overpressurization of the unit. A series of controls 118 and status lights 120 are located on the front of the brewing apparatus 114 to signal the progress of the brewing process and to initiate the sequence of brewing the beverage. A brew basket 122 is releasably secured to the brewing apparatus so that it can be filled with packets of tea leaves for brewing the beverage. As is known in the art, the universal control module 100 initiates brewing by introducing the heated water into the brew basket 122, where the heated water infuses with the tea leaves and produces a concentrated hot tea 125 that flows out of the vertical nozzle 124 and into the bin 110.

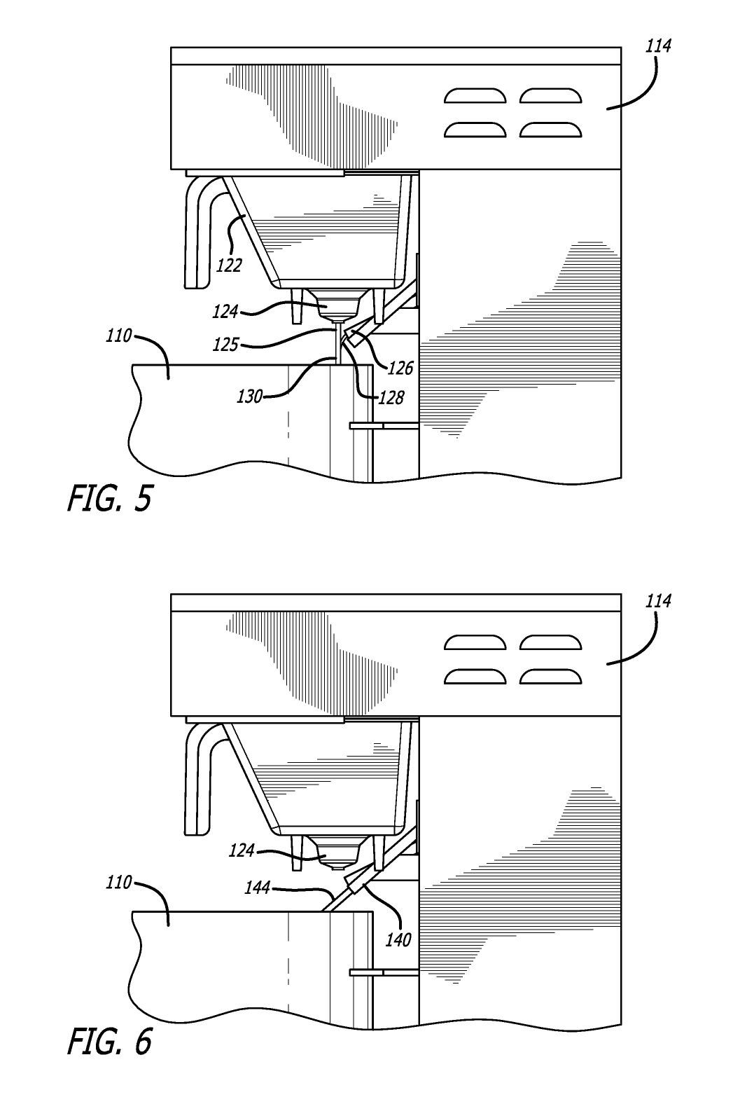

As the high temperature concentrated tea flows from the brew basket 122 to the dispensing bin 110, the time for the complete brew cycle (the time from beginning of the flow of water through the nozzle 124 to the end of the flow through the nozzle) is stored in the universal control module 100. This can be a setting that is entered or selected by a user, or a fixed interval depending upon the application. A concentrated, high fructose syrup 128 or other liquid sweetener is introduced during the brew cycle through nozzle 126. Nozzle 126 is aligned with the nozzle 124 and angled downwardly, between negative forty-five degrees and negative seventy-five degrees from the horizontal, and more preferably about negative sixty degrees from the horizontal (see FIG. 5). This allows the ambient temperature sweetener 128 to be entrained into the hot brewed tea 125 to form a mixed flow 130 prior to entering the dispensing bin 110. Angling the nozzle 126 of the sweetener downward into the flow of the tea 125 increases the residency time that the two liquids share and improves the diluting efficiency of the sweetener. As the two liquids enter and bin, they undergo further mixing to promote full dissolving of the sweetener in the tea without the need for any subsequent manual mixing step.

In a preferred embodiment, the sweetener 128 is introduced at intervals spaced over the complete brew cycle. That is, the UCM 100 causes the sweetener valves 40,42 to intermittently open for ten seconds and then shut for a period selected so that the sweetener can be introduced over the entire brewing cycle. This gradual introduction of the sweetener into the hot tea allows smaller quantities of tea to be entrained into the flow 125, favoring greater dissolving of the sweetener 128. For example, if the sweetener 128 requires sixty seconds to dispense for a full tea brew taking nine minutes, the UCM 100 can be programmed to open the sweetener valves for twelve seconds every minute and forty-eight seconds so that after nine minutes the entire sweetener component will be delivered into the tea. In this manner, more sweetener is combined with the tea and better dissolving is achieved.

A second factor in the mixing process is the introduction of the diluting water through nozzle 140. Nozzle 140 delivers chilled water that mixes with the concentrated tea to produce a beverage that is pleasing to the taste. In the present invention, the nozzle 140 is angled downward and to the rear 142 of the bin 110, and the chilled water is delivered at a high velocity. When the chilled water 144 enters the bin 110, the angle at which it enters the bin creates a turbulent back flow with many eddies and currents that promote mixing of the beverage. In a preferred embodiment, the velocity of the diluting flow 144 is at least twice the velocity of the flow of tea 125 exiting the nozzle 124. This high velocity, angled flow guarantees a high degree of mixing of the beverage in the bin and eliminates the need for a manual mixing step post-brew cycle.

The foregoing describes a one step tea brewing operation where brewed tea, diluting chilled water, and liquid sweetener are combined at multiple intervals to yield a fully mixed sweet tea beverage that is cold and ready to serve to customers. There is no need for workers to hand mix the tea after brewing, or chill the tea after brewing so that it can be served to patrons. Thus, the brewing station is more efficient, more sanitary (since no mixing utensils or hand-held objects are needed to stir the mixture), and more reliable (since precautions are in place to prevent partially brewed batches). The brewing station of the present invention represents significant advantages over prior art tea brewing stations, and these advantages improve both the performance and desirability of the present invention.

While the foregoing descriptions and depictions represent the inventor's best mode of making and using the present invention, it is recognized that there may be various modifications and substitutions that would be known to one of ordinary skill in the art. What's more, these modifications and substitutions do not depart from the scope of the present invention, and in fact these modifications and substitutions are intended to be included as part of the invention. Thus, the present invention should not be interpreted as being limited or confined by any of the exemplary embodiments described herein, and the scope of the invention is properly determined by the words of the appended claims, using the plain and ordinary meanings of the words therein, in light of the foregoing descriptions.

I claim:

1. A tea brewing station, comprising:
a housing including an inlet valve for receiving water from a water source, a tank for collecting and heating water received through the inlet, and a dump valve for regulating heated water into a brew head;
a chilled water supply flowing through a dilution valve to a dilution nozzle;
a supply of liquid sweetener connected to a pump for delivering the liquid sweetener through a sweetening valve to a sweetener nozzle;
a universal control module for controlling the inlet valve, dump valve, dilution valve, sweeting valve, and pump;
a brew basket including a nozzle for delivering a continuous stream of hot brewed tea from the brew head to a collection urn; and
a sweetener nozzle aligned with the nozzle on the brew basket such that liquid sweetener is introduced directly into the continuous stream of hot brewed tea during a brewing operation.

2. The tea brewing station of claim 1, wherein the liquid sweetener is introduced into the continuous stream of hot brewed tea at intervals that occur over the duration of a brew cycle.

3. The tea brewing station of claim 2, wherein the sweetener nozzle is oriented at a downward angle to increase a residency time that the sweetener comingles with the hot brewed tea.

4. The tea brewing station of claim 3, wherein the sweetener nozzle is angled between negative forty-five degrees and negative seventy five degrees from the horizontal.

5. The tea brewing station of claim 3, further comprising a dilution nozzle disposed on the housing for diluting the flow of hot brewed tea, the dilution nozzle oriented askew from a center of the urn and at a downward angle pointed toward a far side of the collection urn to promote mixing of the diluting water with the hot brewed tea.

6. The tea brewing station of claim 5, wherein a velocity of the diluting water through the dilution nozzle is approximately two gallons per minute to stir the concentrated tea using a vortex action.

7. The tea brewing station of claim 5, further comprising first and second bibs of liquid sweetener, each bib feeding a separate sweetener valve and each bib having an associated sweetener pump, where the universal control module controls the first and second pumps and the first and second valves to regulate the flow of sweetener into the collection urn.

8. The tea brewing system of claim 7, where the first and second pumps are driven by a pressurized carbon dioxide canister, where the first and second pumps include a pressure switch and a bleed hole, where the bleed hole counts a pulse connected to the pressure switch and bleed off pressure to ensure volumetric accuracy independent of sweetener viscosity.

9. The tea brewing system of claim 3, where a dosing of the sweetener into the hot brewed tea occurs approximately every ten seconds to distribute the introduction of the sweetener into the tea over a majority of the brew cycle.

10. The tea brewing system of claim 3, wherein the diluting water is chilled to lower a temperature of the mixture after the brewing cycle.

11. The tea brewing system of claim 7, wherein when a first sweetener bib 30 is empty, an error message is displayed while the other sweetener bib is used, and the universal control module monitors an operation of the pump associated with the empty bib, and limits the number of brew cycles that can be brewed before the empty sweetener bib is replaced.
